(19) United States
(12) Patent Application Publication
(10) Pub. No.: US 2025/0086427 A1
(43) Pub. Date: Mar. 13, 2025

(54) A Method and System for Generating Optimal Machine Learning Model Architectures

(71) Applicant: Modlee, Inc., New Haven, CT (US)

(72) Inventor: Bradley James Magnetta, New Haven, CT (US)

(21) Appl. No.: 18/882,621

(22) Filed: Sep. 11, 2024

Related U.S. Application Data
(60) Provisional application No. 63/581,873, filed on Sep. 11, 2023.

(51) Int. Cl. G06N 3/045; G06N 3/084; G06N 3/092

(52) U.S. Cl. CPC G06N 3/045; G06N 3/084; G06N 3/092

(57) ABSTRACT

A system and method capable of learning connections between machine learning (ML) datasets and optimal ML models to perform model selection for many different dataset types, ML task frameworks, and ML applications. A system and method for generating a desired machine learning model representation by providing as input a dataset representation and one or more target requirements representations for the desired machine learning model representation, training a transformer using a system dataset including a number of machine learning experiments, each machine learning experiment having an associated dataset representation, target requirements representation, model representation, and performance representation, and using the transformer to generate the desired machine learning model representation having a performance representation which equals or exceeds the target requirements representation.

### CROSS REFERENCE TO RELATED APPLICATIONS

Applicant claims priority and the benefit of U.S. Provisional Application No. 63/581,873, filed Sep. 11, 2023, the disclosure of which is incorporated herein by reference.

### FIELD OF THE INVENTION

The present invention generally relates to the fields of machine learning (ML), deep learning, MLOps, ML R&D, and ML engineering. More specifically, the present invention relates to a method and system for generating machine learning model architectures.

### BACKGROUND OF THE INVENTION

Machine learning (ML) models act as predictive mappings between numerical inputs and numerical outputs. While inputs can have any dimension or numerical form, common input types are images which are integer valued three-dimensional tensors (N-row pixels, M-column pixels, 3 red-blue-green integer values). ML models transform the input using a series of mathematical operations. Referring to FIG. 1, these mathematical operations are represented pictorially as a series of different shapes, corresponding to different mathematical operations that may affect both the numerical values and dimension resulting in an output value returned by the model. In the case of a classification problem or application, this output may be N predicted values representing the likelihood that the input belongs to N classes. For the specific case shown in FIG. 1 (i.e., input image of an automobile), the ML model returns 10 numerical values each indicating a likelihood of classification of the input image (automobile), with the maximum value corresponding to the index related to automobiles.

ML models do not perform accurate predictive mappings for input datasets without training ahead of time. FIG. 2 demonstrates an image classification example, where the ML model is trained to identify four classes (airplanes, automobiles, birds, and cats). As shown in FIG. 2, training may involve an iterative process of passing a single input or set of inputs (batch), represented by a column of the data table, to the current state of the ML model to receive current state outputs. Then, current state outputs are compared against the ground truth (correct) values and an error is calculated. Using backpropagation, this error is propagated backwards to all the mathematical operations of the ML model forming a set of error gradients. These gradients can then be used with a gradient descent algorithm to change the ML model's mathematical operations in such a way that the error of the ML model's outputs is reduced. This process is repeated many times until the entire dataset has been passed through the ML model, representing a single epoch. Many epochs are needed to get an accurate ML predictive mapping on a single dataset, and the reduction of error is expected with each epoch.

There are a large number of possible machine learning models that could be trained on a specific dataset and some models are more effective than others at yielding more accurate predictions of dataset outputs from inputs. ML models use a sequence or set of many mathematical objects (illustrated by different shapes in FIG. 3) to create their predictive mappings, and the unique order and amount of these objects comprise the ML model itself (illustrated by the different sequences of shapes in the middle of FIG. 3). As illustrated in FIG. 3, machine learning datasets trained and evaluated on a specific machine learning model represents an ML experiment. Each ML model has a specific set of mathematical objects which influence the performance of the entire trained ML model on an evaluation portion of the dataset. The type and amount of mathematical objects used within a model determine performance attributes of the model such as accuracy on an evaluation dataset, model memory size (the file size of storing the model for future use), and model inference speed (the time taken to process a single input).

These performance attributes are then used to decide which model is sufficient for a particular application based on a set of performance based target requirements for an ML solution. For instance, if an ML solution is desired to be operated in a cloud environment, the model memory size is not as important (cloud environments can easily adapt to different model sizes). However if an ML solution is desired to be operated in a microcontroller (small computer) then the model memory size must be very small. Once a particular model is decided upon, software is built around certain models allowing people to interact with and utilize the model, for example, to pass inputs to the model and then obtain outputs from the model.

The process of training a single specific ML model on a specific dataset and then evaluating the performance of that ML model is referred to as an ML experiment. ML personnel must run many experiments in order to obtain a trained ML model that satisfies the desired requirements for a ML based predictive solution. As a rough estimate of the world wide ML experiments run each year, 30K ML professionals each running on average one ML experiment per day results in 10 Million experiments each year.

Datasets with large dimensions can require expensive computing and/or significant time to train a single model; the entire experimentation process can take months for some ML projects to find a suitable trained model that meets the target requirements of an ML based solution. This results in the ML R&D process as being a bottleneck for ML innovation and business development. Moreover, often in industry models are optimized for multiple factors such as accuracy, memory size, inference latency, etc. . . . which can increase the complexity of the experimentation process.

The most common approach to ML R&D is manual model architecture design which involves a person selecting models to experiment with based on trial and error, past intuition, and community results (research papers or shared code).

It is common for ML organizations to document and track their experimentation using MLOps tools such as MLFlow (an open source tool). Doing so allows organizations to track their progress on projects over time and gives them the ability to reproduce each experiment when desired. Documentation involves saving a given machine learning model, and storing parameters required for reproducing the experiment. These parameters often include the number of data elements passed through the model at a time during training (batch size), the number of times a full dataset is passed through the model (epochs), optimization parameters (gradient algorithm, learning rate), performance metrics (accuracy, loss), etc. . . . While documenting and tracking project progress over time are useful for identifying the best models within an area of experimentation, there are not currently systematic methods for leveraging this documented experimentation to dramatically improve the ML R&D process by reducing the amount of future experimentation needed.

It is common for organizations to train models on large databases, which are called foundation models, and give access to these models to others. Foundation models are trained for a specific ML task, and often require continued training or alterations to be used for new tasks. If the task is similar to the one the foundation model was trained for, it is possible to regard the output of a particular mathematical object within the foundation model as “features”, a new representation of the input. These features can then be generated for entire datasets and act as inputs to an untrained model, which trains (or develops) a mapping between the foundation model features and a new ML task. However, when the ML task is significantly different from the one the foundation model was trained for, fine tuning of the foundation model mathematical objects may be needed. This involves creating a model consisting of trained foundation model elements and untrained new elements, continuing to train a small percentage of mathematical objects of the model while fixing the rest, and then gradually increasing the proportion of mathematical objects for continued training in steps until the full model is retrained on the new dataset. While both of these approaches, feature extraction and fine tuning, can help speed up the training process when searching for optimal models for new tasks, extensive experimentation is still needed and there do not exist foundational models for every ML task.

Automated Machine Learning (AutoML) are methods for automatically identifying optimal machine learning models for a particular dataset. Most current AutoMLs are iterative processes that still require extensive experimentation. This experimentation is dataset dependent, and learnings are not carried over between different uses of the AutoML. AutoML is often also called Neural Architecture Search (NAS). One example of such an iterative process is presented in U.S. Pat. No. 11,675,581, the contents of which are hereby incorporated by reference in their entirety. Another example of such an iterative process is presented in U.S. Pat. No. 11,665,317, the contents of which are hereby incorporated by reference in their entirety. Yet another example of such an iterative process is presented in U.S. Pat. No. 11,645,495, the contents of which are hereby incorporated by reference in their entirety. An example AutoML process is shown in FIG. 6, wherein a Variable ML model definition allows for dynamic definition of ML models. Two common machine learning model mathematical operations are fully connected (FC) and convolutional (Conv) layers. The grid in FIG. 6 depicts the models that are possible with a variable definition based on a model consisting of both FC and Conv layers. The axes of the grid correspond to the number of FC Layers and the number of Conv Layers, with each data point representing a different model and its evaluation accuracy. In the specific example illustrated, the exploration or searching for a suitable model begins at node (1, 1) with accuracy of 56% and proceeds to node (2, 2) with accuracy of 72%, and then to node (3, 1) with accuracy of 54%. Next is node (2, 3) with accuracy 79%, followed by node (4, 2) with accuracy 79%, followed by node (5, 4) with accuracy 91%, and then finally to node (3, 4), with accuracy 96%. Exploration of the grid can be automated via random search, optimization based search, or other approaches until a sufficient model is found. This process requires the training of many models.

The most basic AutoML requires defining a model with a set of mathematical objects that are parameterized. Changing a parameter influences the characteristics of the mathematical object. One example of the use of parameterized models is set forth in U.S. Pat. No. 11,669,780, which is hereby incorporated by reference in its entirety. Parameterized models allow for the generation of a set of unique models with only a few control parameters. From here, a basic AutoML can be devised which randomly selects a set of model parameters, trains that specific instance of model, and then repeats the training many times until a model is found that performs satisfactorily. Once a model is parameterized, optimization algorithms can be used instead of random parameter selection to more efficiently determine the parameters that correspond to the optimal model. However, this optimization problem is highly non-linear which means basic optimization approaches often fail at finding the optimal model. KerasTuner is an example of an open source AutoML framework similar to the methods just described.

Another approach to AutoML is through genetic algorithms. This approach involves training a small number of models (selected randomly), augmenting the best performing model slightly, training a small set of random models in addition to the augmented best model, and repeating this process. This approach is iterative and dataset dependent which does not reduce the amount of experimentation needed to find optimal models. An example of such an iterative, dataset dependent approach is shown in U.S. Pat. No. 11,640,563, the contents of which are incorporated by reference herein in their entirety. An example of such use of genetic algorithms is illustrated in FIG. 7, wherein Genetic algorithms for AutoML train a set of starting models, select the most promising, and create similar variations of models called child models to continue ML training and exploration in an automated way.

Reinforcement learning (RL) is another common approach for AutoML. Here the model definition (the mathematical objects used) is controlled through a reinforcement learning process. A model is defined, trained, and incentivized to change in such a way that performance is maximized. While this approach has shown to find unique architectures that are very competitive with the best performing models for specific tasks, this process is iterative and reinforcement learning methods are historically time consuming due to their inability to learn quickly. In addition, RL methods are also dataset dependent, which means no knowledge is passed on to future uses of the algorithm. As a result, RL methods for AutoML do not reduce the amount of experimentation needed to find optimal models.

Other approaches exist that attempt to reduce the cost of each experiment by predicting the trained weights of model architectures without having trained them (e.g., SMASH). While a method such as this could reduce the amount of time required by each experiment and reduce the amount of time required of the entire experimentation process to find an optimal model, it is iterative and dataset dependent. Further, it does not share knowledge between different uses of the tool on different datasets.

Common drawbacks of iterative AutoMLs include the time taken for experimentation, dataset dependency, and their inability to handle custom ML Tasks or model architectures effectively.

Recently generative model selection methods have been proposed to utilize large language models to select which ML models to train. Each of these methods attempts to use a pre trained generative AI such as OpenAI's ChatGPT, which was trained on general human written text and adapted to conversational tasks, as an ML assistant to determine the models that should be trained for a given task when prompted with a specific text. As a result the inputs or prompts to the generative AI must resemble human text, because this is the type of data that the generative AIs were trained on. Adjusting the prompts of a pre-trained generative AI to optimize the generated content is known as prompt engineering, of which the above methods are focused on. FIG. 8 illustrates how to iteratively use a pretrained model to determine which model to train and evaluate through prompt engineering. As shown, the process starts by determining/adjusting a model selection prompt, then using a pre trained large language model to obtain or describe a suggested ML model, training and evaluating the suggested model, and repeating the process until a satisfactory model is obtained, for example in terms of performance or error. In addition, these methods rely on ML experiment results shared on community platforms for specific datasets and specific models to make their ML model selections. As a result, the generative AI has a coarse view on how different models influence performance for a variety of datasets which could in theory limit the effectiveness of such techniques for actually finding optimal models.

### SUMMARY OF THE INVENTION

The present invention addresses these and other shortcomings of the prior art as discussed above. The present invention is directed to a method and system for generating optimal machine learning model architectures which does not rely on an iterative AutoML approach. Further, the present invention is not focused on prompt engineering of an existing trained large language model (LLM) that was trained on human written text. Prompt engineering refers to the process of changing the input to the LLM to maximize the output of LLM without changing the LLM. In other words, the model stays the same, but it is the input which is modified in order to achieve a more correct output from the model.

According to one embodiment, the present invention may learn connections between ML datasets and optimal ML models to perform model selection for many different dataset types, ML task frameworks, and ML applications. One example application of the present invention may utilize image data within the framework of image classification for facial recognition.

To train the system to learn the connection(s) between ML datasets and optimal ML models, a “system dataset” is formed and includes one or more of the following data elements: a representation of the ML dataset, a representation of desired performance target requirements and model attributes for a ML solution, a representation of a model's composition that describes its mathematical objects, a representation of the performance of the corresponding model on an evaluation ML dataset. A system dataset may include the data elements from any number of sources or organizations, and as a result may include many different variations for each representation. An illustration of a system dataset example is shown in FIG. 9, wherein a numerical ML dataset (such as a collection of images) is converted to a dataset representation, a specific ML model trained on the ML dataset is converted to a Model representation, the performance of the model is converted to a performance representation. A simulated set of user based target requirements are converted to a target requirements representation and retroactively added into the example.

According to some embodiments of the present invention, a system trained on a system dataset as described herein would be comprised of a ML statistical technique or model itself which may include elements of the following common methods: regression algorithms, instance-based algorithms, regularization algorithms, decision tree algorithms, Bayesian algorithms, clustering algorithms, association rule algorithms, artificial rule learning algorithms, artificial neural network algorithms, deep learning algorithms (such as convolutional, fully connected), dimensionality reduction algorithms, ensemble algorithms, graph neural networks, large language models, transformer based algorithms, attention/self-attention based algorithms, and/or the like.

According to one embodiment of the present invention, a system may include a decoder-only transformer that is trained directly on the system dataset in an auto-regressive manner for data clement completion (see FIG. 10). Referring to FIG. 10, therein is illustrated a specific instance of a transformer based system, and how to train it. A system dataset example is processed, resulting in a sequence of example “units”. An input (a portion of the dataset) is passed through the transformer resulting in an output representing a next portion of the dataset. The output is compared against the known value to determine the error. The error is used to update and adapt the transformer to minimize the error in the future following standard transformer training methods. The input is increased by one more unit and the process is repeated until the entire example is exhausted. A new example is then trained over. A system trained in this way would learn correlations between each representation in the system dataset and be able to generate later representations when conditioned or prompted with a portion of the dataset. As a result, the system would be able to suggest optimal ML model architectures for any ML dataset, within the domain of the system dataset when prompted with an input data and target requirements representation.

Once the system is trained, a user provides a dataset representation and target requirements, and the system is capable of generating an optimal model architecture with predicted performance. However, depending on the elements included in the system, the system may be able to suggest optimal model architectures that are not included in the system dataset, which consist of a unique combination of mathematical objects that the system was trained on. Such a scenario may be possible if certain elements are included, such as one or more of: large language models, transformer based algorithms, attention/self-attention based algorithms.

According to embodiments of the present invention, a system would significantly reduce the experimentation required to find optimal models for datasets. As a result, the present invention may dramatically impact business development where ML models are a focus by making ML R&D faster and thus leading to more time and opportunities for organizations that use the system and method, resulting in better efficiency and utilization of resources, along with reductions in expenses. The present invention may also facilitate a marketplace or information exchange where different implementations of the system can be trained, stored, hosted, rented, bought, and sold. This marketplace could be built in an interactive manner, such as a website or desktop application.

### BRIEF DESCRIPTION OF THE DRAWINGS

Other objects, features and advantages of the invention discussed in the above brief explanation will be more clearly understood when taken together with the following detailed description of an embodiment which will be understood as being illustrative only, and the accompanying drawings reflecting aspects of that embodiment, in which:

FIG. 1 is a diagram demonstrating the process of taking an input data (a single data element from a larger dataset such as an image from CIFAR10), passing it to a machine learning model, and obtaining an output;

FIG. 2 is a diagram illustrating an image dataset divided into batches (columns) and each batch is used to train an ML model by producing error between predicted image classes and know classes, using this error to update the model;

FIG. 3 is a diagram illustrating machine learning datasets trained and evaluated on a specific machine learning model representing an ML experiment;

FIG. 4 is a table showing experiment parameters (including trained numerical model) and how they are commonly documented using a file storage system;

FIG. 5 is a diagram illustrating an image dataset with four classes being split into “batches” (in this cases four images), each batch is passed through the first few mathematical objects of a pretrained model (foundation model) first before a series of custom mathematical objects;

FIG. 6 is a diagram illustrating a basic AutoML: Variable ML model definition which allows for dynamic definition of ML models, with the grid depicting the models that are possible with the variable definition;

FIG. 7 is a diagram illustrating genetic algorithms for AutoML used to train a set of starting models, selecting the most promising, and creating similar variations of models called child models to continue ML training and exploration in an automated way;

FIG. 8 is a diagram depicting how to iteratively use a pretrained model to determine which model to train and evaluate through prompt engineering;

FIG. 9 is a diagram illustrating a system dataset example having a dataset representation, a target requirements representation, a model representation, and performance representation;

FIG. 10 is a diagram illustrating an embodiment of a transformer based system, and the process of training;

FIG. 11a is a diagram illustrating how a pre-trained deep learning model is used to provide a new representation of an input using the output of a specific layer within the model;

FIG. 11b is a diagram illustrating dimensional reduction to take an input of a higher dimension and map it to a new representation of a lower dimension;

FIG. 12 is a flowchart illustrating a method for training a machine (deep) learning model on a dataset to produce input features, and as a result a new representation of the dataset, according to an embodiment of the present invention;

FIG. 13 is a flowchart illustrating a dataset converted to a new representation (Features) using a feature extractor, according to an embodiment of the present invention;

FIG. 14 is an illustration of how an image dataset can be clustered by an ML based technique;

FIG. 15 is an illustration of an elbow plot used to determine the optimum number of classes for an unsupervised technique with a plot of inertia at different number of classes to define feature attributes for unsupervised problems;

FIG. 16 is a flowchart illustrating a single dataset passed through multiple different feature extractors to create multiple different features;

FIG. 17 is an illustration of three different representations of the same model architecture;

FIG. 18 is a table illustrating the steps for converting an ML experiment into a representation that large language models can train on;

FIG. 19 is an illustration of an autoregressive ML model (such as a transformer based LLM) trained on a system dataset with specified structure; and

FIG. 20 is an illustration of discretization of numbers to create a finite and tractable numerical specific vocabulary for text based learning models;

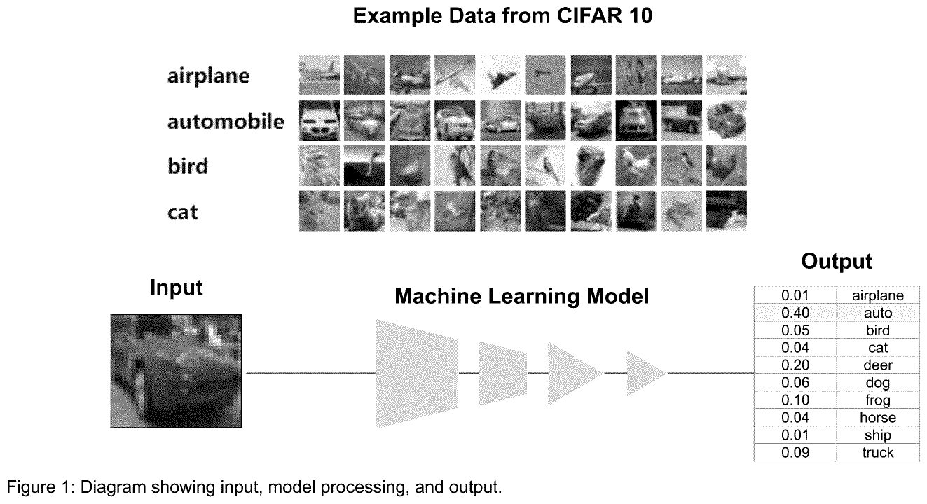

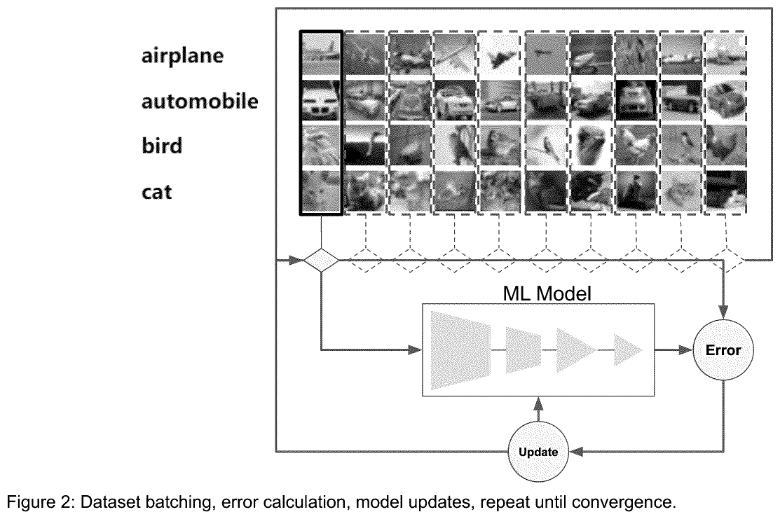

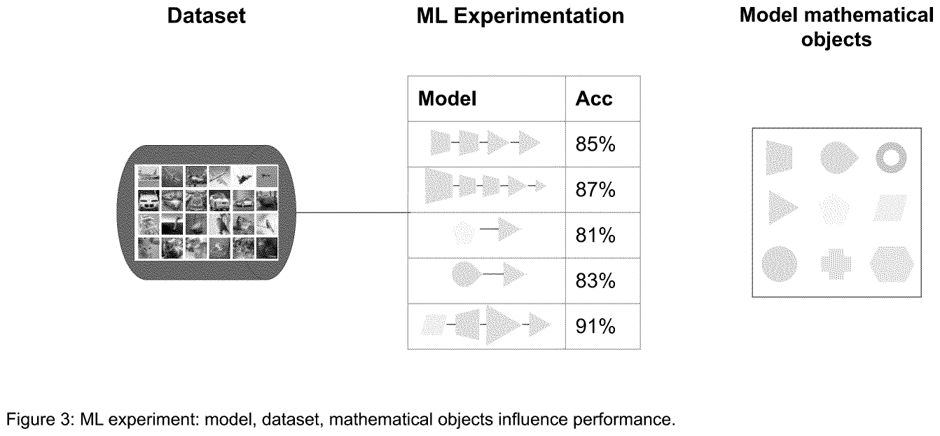

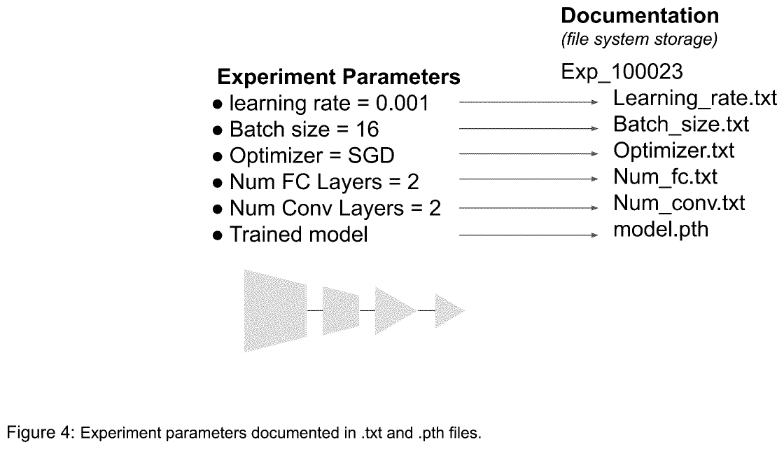

### DETAILED DESCRIPTION OF THE INVENTION

### Dataset Representations

A “dataset representation” may include “general attributes” of a collection of numerical data (dataset). This includes, but is not limited to, the number of data elements in a dataset, the size and shape of each data element (scalar, vector, multi-dimensional tensor, etc . . . ). In the case of classification, when data elements are paired with a class label (a word or integer organizing the dataset into classes), statistics (mean, standard deviation, etc . . . ) describing label diversity can also be representative of the dataset. In the case of text data, statistics on the vocabulary of the text dataset (such as word count, mean word count, standard deviation of word count, max word count, min word count, etc . . . ) can be used as general attributes. By vocabulary, we mean the collection of unique words in a dataset. In order for text data to be compatible with machine learning methods it must be converted to a numerical form. This may be done on the character level (where each letter is replaced with an integer), word level (where each word is replaced with an integer), or words level (where unique sequences of words are replaced with an integer).

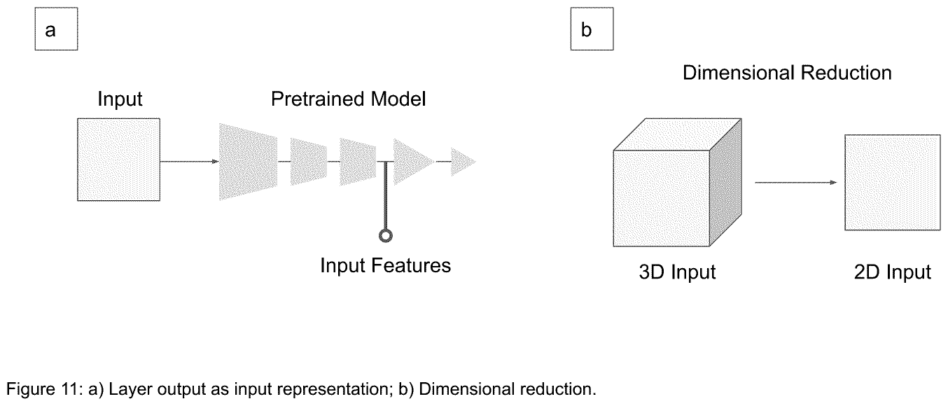

A “dataset representation” may include “feature attributes” of a dataset where “features” refers to a new representation of a data element (or input), which are obtained from the output of a specific mathematical object in a machine (deep) learning model. Referring now to FIG. 11a, therein is illustrated how features for an input can be obtained from a pre-trained deep learning model by taking the output of an intermediate or middle mathematical object as features. Pre-trained models are usually only compatible with data of specific shapes and as a result, manipulation of a dataset may be required to obtain features from a specific dataset. In the case of text data, the output of a pre-trained model may be useful for features when the pre-trained model performs summarization, keyword identification, etc Likewise, for image data, the output of a pre-trained model will describe which class labels most likely correspond to the dataset, and even if the new dataset does not contain those class labels, the pre-trained model's predictions may serve as useful features. However, beyond the output of a pre-trained model, a mathematical object prior to the output may produce features that are very useful in representing the dataset in a reduced dimension.

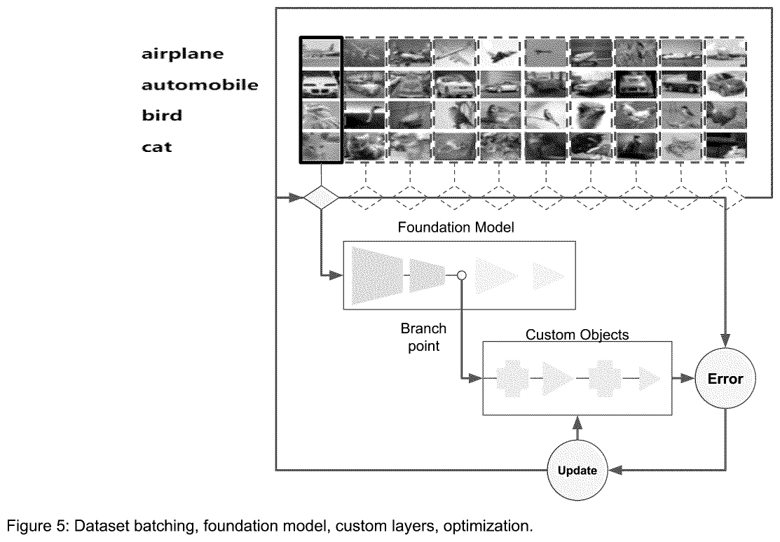

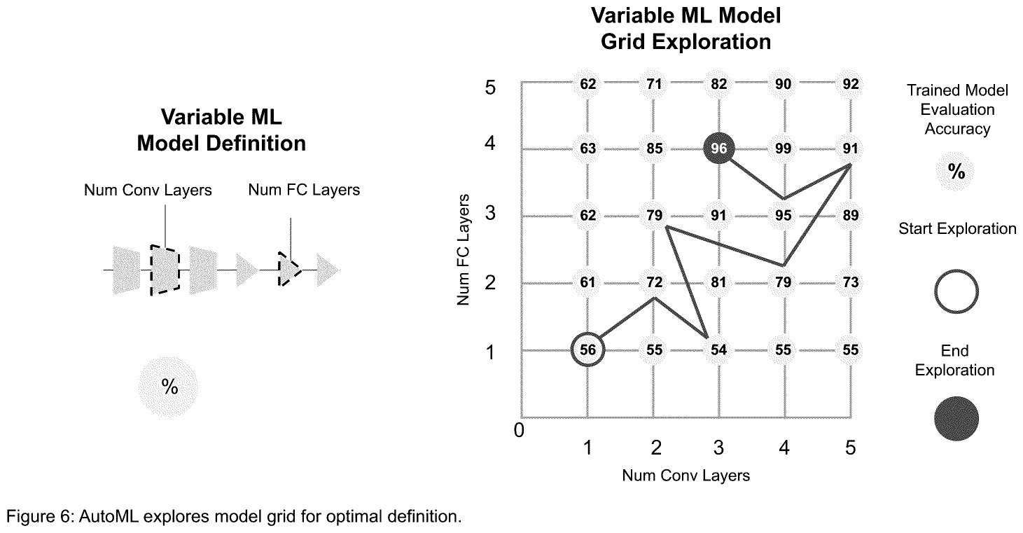

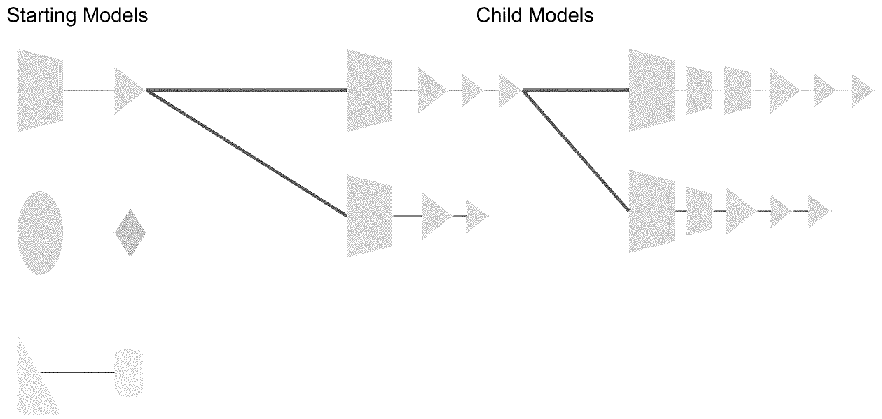

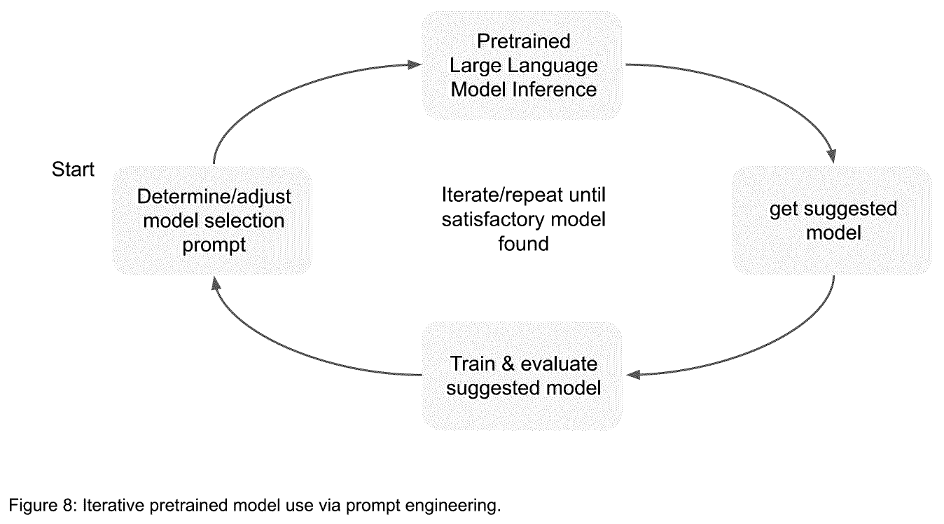

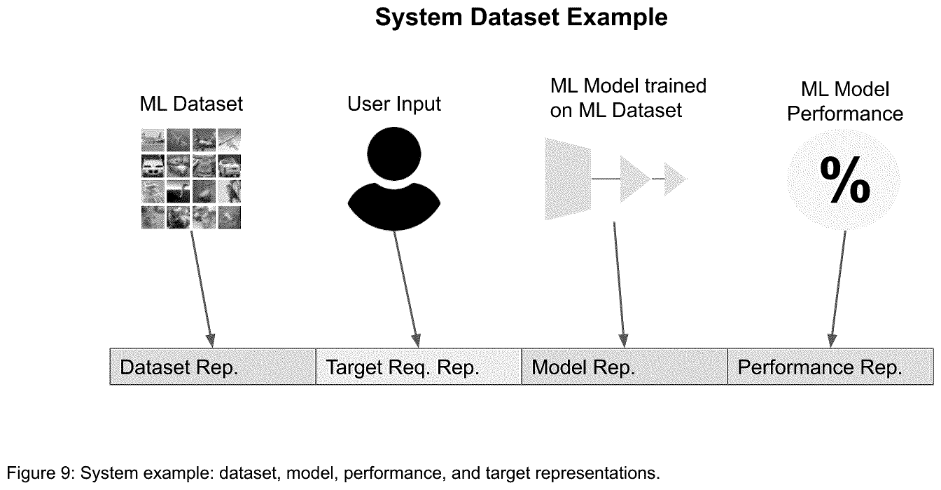

Another method to obtain features may be to train a model on many datasets of similar characteristics (for example: many image datasets), as shown in FIG. 5. Here, a mathematical object within the model would be taken as features. In the case of classification, a model may be chosen and trained to predict class labels for each data element for a large number of classes. Referring now to FIG. 5, therein is illustrated an image dataset with four classes split into “batches” (in this case four images). Each batch is passed through the first few mathematical objects of a pretrained model (foundation model) up to a “branch point” first before being passed through a series of custom mathematical objects. The output of the last custom object is compared against the known outputs for the batch and the error is calculated. This error is used to update and adapt the custom objects through backpropagation and gradient optimization. The full dataset is passed through the entire system many times until the error is sufficiently reduced.

However, an approach that would work for both supervised and unsupervised datasets would be to choose a model such that the output is the same dimension as the input, and an error is chosen such that the model is trained to take an input data, compress it down to a lower representation, expand this lower representation up to the original input data size, and penalize the output when it differs from the input. Auto-encoders are an example of models that do this. In this way, a model can be trained to produce lower dimensional features of a dataset.

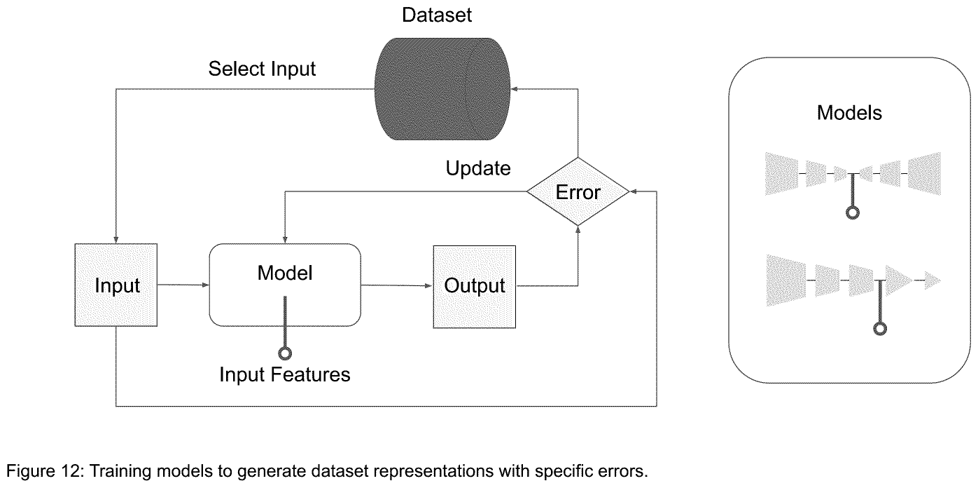

Another method to obtain features may be to train a model on many datasets of different types (images, text, audio, tabular, etc . . . ). This approach would be similar to that described in FIG. 12, but specific mathematical objects would need to be applied to each dataset type in order to make them all compatible with the same model. This is illustrated in the right-hand portion of FIG. 12. Specifically, FIG. 12 illustrates a method for training a machine (deep) learning model on a dataset to produce input features, and as a result, a new representation of the dataset. Many different types of models could be chosen for this process, where the output has different meaning and the error (loss function) is chosen to be compatible with those outputs.

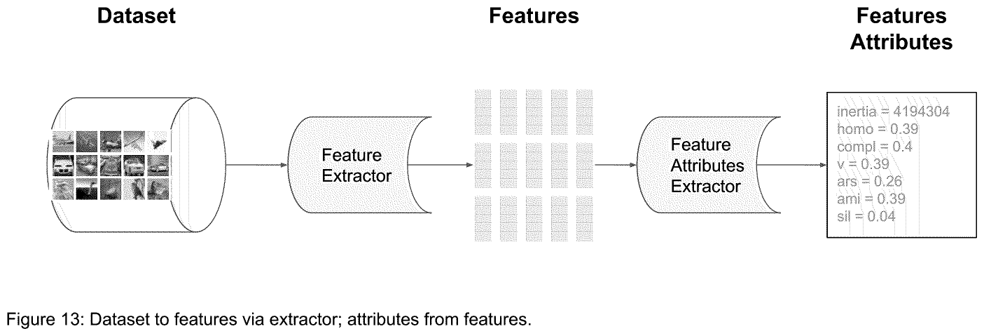

The “feature attributes” of a dataset may also refer to statistics gained from particular features of a dataset. This is illustrated in FIG. 13, which illustrates a dataset converted to a new representation (features) using a feature extractor. In this way, attributes may be derived from features. Referring to FIG. 11a therein is illustrated a method (Feature Extractors) for extracting input features which act as a new representation of the input that are used in ML model training. Attributes can be derived from features by applying statistics (including, but not limited to, mean and standard deviation). In addition, statistical based ML methods may be applied to the features and statistics may be gathered from the outputs of these methods which act as feature attributes. Feature attributes are effective at indicating how effective the corresponding features are at representing the dataset and help to measure the complexity of the dataset.

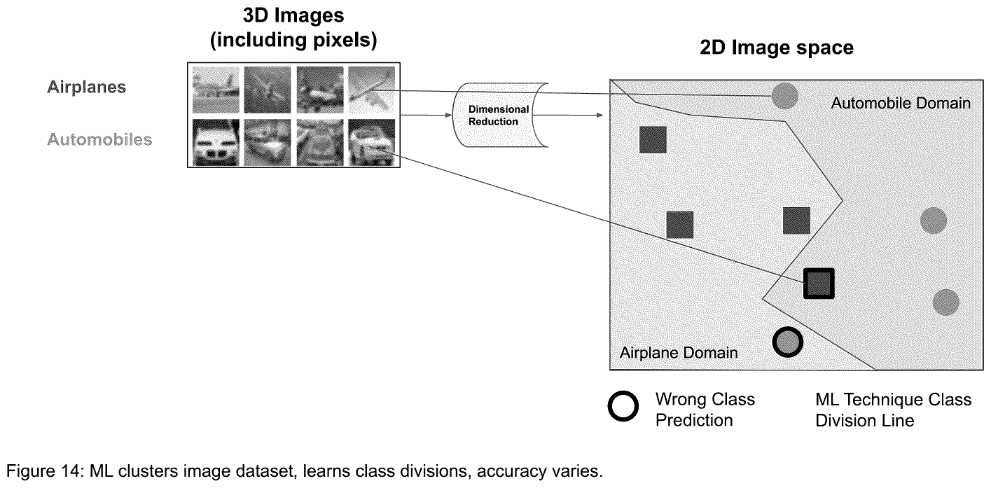

In the case of a supervised classification problem, a class label may be assigned to the features of each dataset element. As a part of a feature attributes extractor, ML based techniques (including, but not limited to k-means) can be applied, clustering the features into N classes, where N is the number of known classes in the dataset (unique number of class labels). This process is illustrated in FIG. 14, which illustrates how an image dataset can be clustered by an ML based technique. The ML technique learns a “division line” separating the classes in the dataset. ML techniques are typically less accurate when datasets are more complex. In the example shown in FIG. 14, the division line is used to separate between the “automobile domain” and the “airplane domain” to separate the classes in the dataset. In the example shown, there are two errors with respect to the division line, i.e., one airplane data point is in the automobile domain, and one automobile data point is in the airplane domain.

An estimation may be established as to how well the ML based clustering performs in comparison to the known class labels. Additionally, statistics (clustering evaluation metrics) may be calculated, and may include feature attributes, such as inertia, homogeneity, completeness, V-measure, Rand Index, Adjusted Mutual Information (AMI), and Silhouette Coefficient. Specifically, inertia is a measure of how well a dataset was clustered by K-Means. It is calculated by measuring the distance between each data point and its centroid, squaring this distance, and summing these squares across one cluster. Homogeneity is a measure of how much each cluster contains only data points of a single class. Completeness is a measure of how many data points of a single class are contained within a single cluster. V-measure refers to the harmonic mean between homogeneity and completeness. Rand Index is a computation of a similarity measure between two clusterings by considering all pairs of samples and counting pairs that are assigned in the same or different clusters in the predicted and true clusterings. Adjusted Mutual Information (AMI) refers to an adjustment of the Mutual Information (MI) score to account for chance. It accounts for the fact that the MI is generally higher for two clusters with a larger number of clusters, regardless of whether there is actually more information shared. Silhouette Coefficient is a calculation using the mean intra-cluster distance and the mean nearest-cluster distance for each sample.

For example, in the case of a supervised regression problem, a scalar will be assigned to the feature representation of each dataset element. ML based techniques (including, but not limited to, support vector machines) will predict the scalar from each feature representation, and statistics can be used as attributes. These statistical calculations may include Mean Squared Error, which is a measure of the average of the squares of the errors between the predicted scalar value and the actual scalar value.

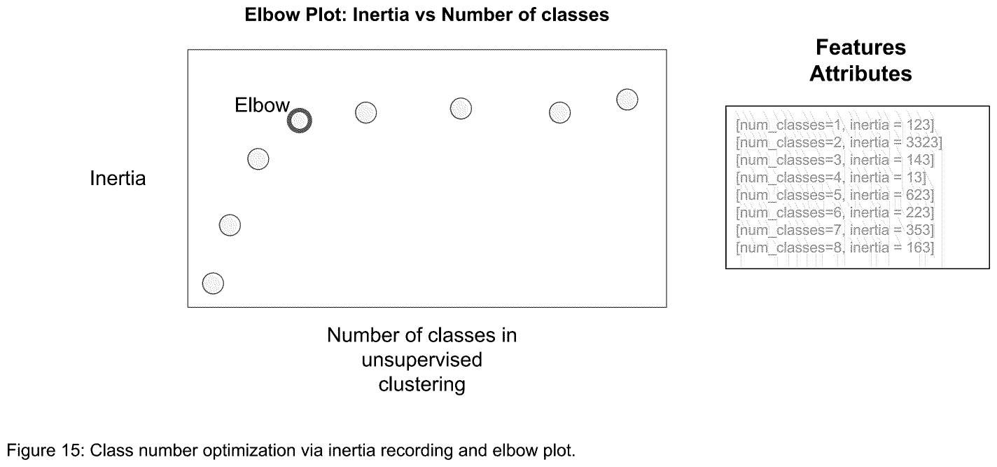

In the case of an unsupervised problem where no additional information is provided for feature representations of each dataset element, ML based techniques (e.g., k-means) may be applied in order to cluster the features in N classes, and vary N between 1 and some larger number. Statistical analysis, such as inertia (described above), may be used to measure how effective the N-clustering is and gather inertia values for different values of N. This process describes an “elbow method” (as shown in FIG. 15). With reference to FIG. 15, the number of classes is typically the main parameter that needs to be defined for unsupervised clustering. Typically, an elbow plot is used to determine the optimal number of classes for an unsupervised technique, where the elbow of the curve corresponds to the optimal number of classes. In an embodiment, the present invention expands on this approach by recording inertia at different numbers of classes to define feature attributes for unsupervised problems. In one aspect, the goal is not necessarily to select the best N value, but rather to gather statistics for different values of N which act as feature attributes.

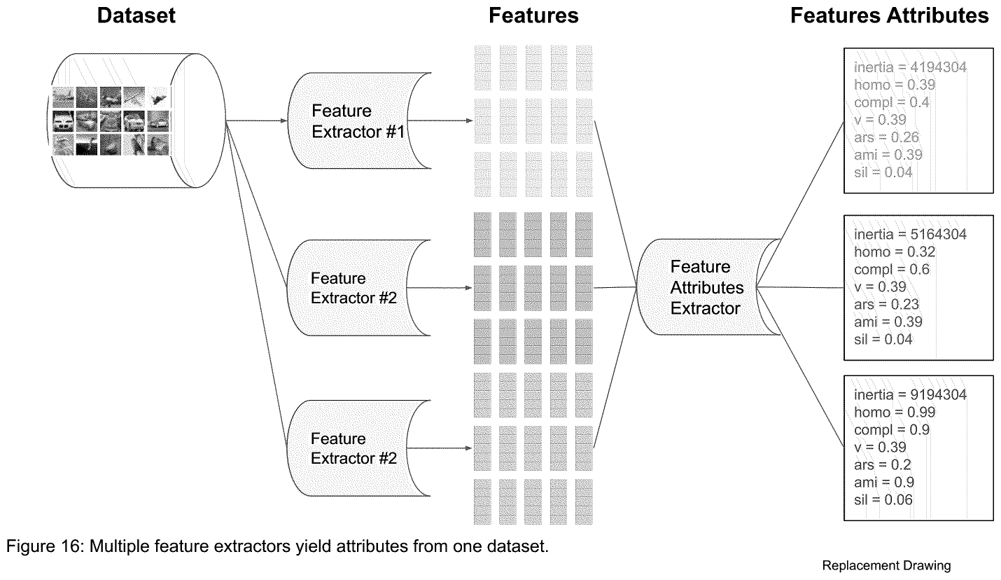

According to certain embodiments of the present invention, gathering multiple unique features for a dataset and gathering feature attributes will provide a useful detailed description of the dataset (See FIG. 16). With reference to FIG. 16, a single dataset may be passed through multiple different feature extractors to create multiple different features. These features can then be independently passed through the same feature attributes extractor to obtain attributes for the different features. Comparing feature attributes for many instances of features helps to identify which features are the most effective, and thus the most effective feature method. As a result, complexity of the method is then correlated within the feature attributes themselves. When building a “system” as described herein, with the purpose of learning connections between datasets and optimal models, consistently gathering specific features for all datasets included in a “system dataset” will allow for these connections to be learned.

### Target Requirements Representations

Target requirements typically refers to the desired performance attributes of a trained machine learning model. According to certain embodiments of the present invention, a target requirements representation is text based and lists the values of desired performance metrics of a trained ML model which may include, but are not limited to, the following: classification accuracy (including top-k), mean squared error, memory size of model in number of trainable parameters and file size (mega-bytes), latency of model (time it takes to return output for single input), confusion matrix, time needed to train model, computing resources available, etc. These values can be evaluated for a single evaluation dataset, listed explicitly for multiple evaluation datasets, or comprise statistical values of multiple evaluation datasets (such as mean, standard deviation, maximum, minimum). Evaluation datasets refer to a set of data that a model was not trained on, but which is only used for evaluating the performance of a trained model.

Additional desired model characteristic requirements may also be provided within the target requirements representation such that only model representations that include these key characteristics are produced by the system. Additional desired model characteristics may include, but are not limited to, specific types of mathematical objects which given the format of the model representation chosen may represent aspects of a specific open source or custom ML coding library. For example, if “fully connected” is listed as a key characteristic, then only models that contain fully connected objects are desired by the user.

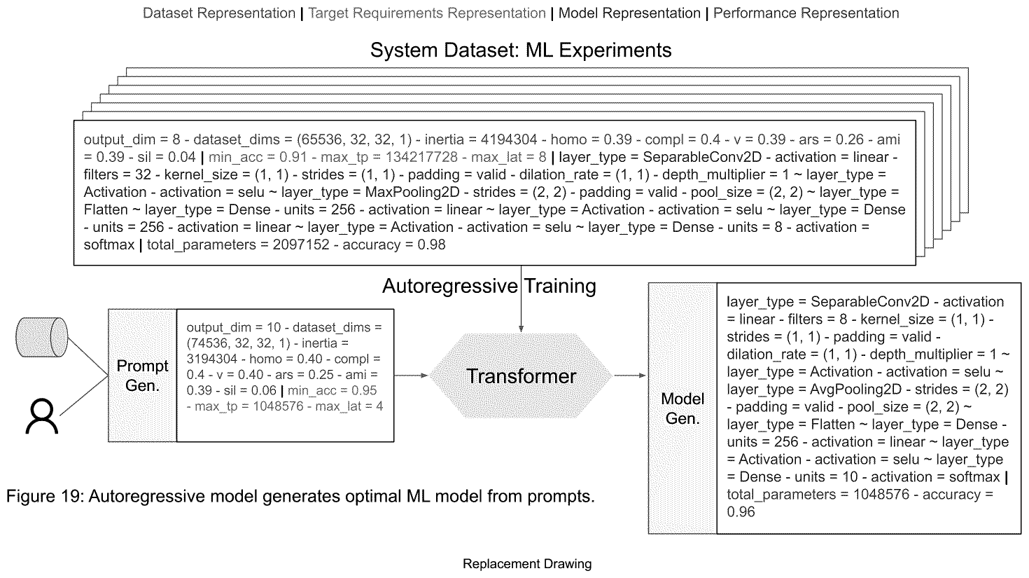

The importance of the target requirements for the system dataset is to incorporate a filtering mechanism into the system data element such that specific instances of dataset representations, model representations, and performance representations satisfy a specific instance of a target requirements representation. Referring now to FIG. 19, therein is illustrated an autoregressive ML model (such as a transformer-based LLM) which is trained on a system dataset with specified structure. Once trained, a user provides a dataset and target requirements to a prompt generator. The prompt is passed to the transformer, and an optimal model with predicted performance is generated. For example, as shown in FIG. 19; the “min_acc” variable in the target requirements representation (which represents the minimum allowed accuracy desired for a trained ML model) is lower than the accuracy listed in the performance representation.

Typically, a set of target requirements will satisfy a given set of dataset, model and performance representations. This will typically result in the creation of multiple instances of a given set with different satisfying target requirements, and all of them will be included within the system dataset. For example as shown at the bottom of FIG. 19, for a target requirement of “min_acc” of 0.95 is satisfied when a performance representation has “acc” of 0.96. Thus, target requirements with min_acc less than the accuracy listed in the performance representations may be included.

### Model Representations

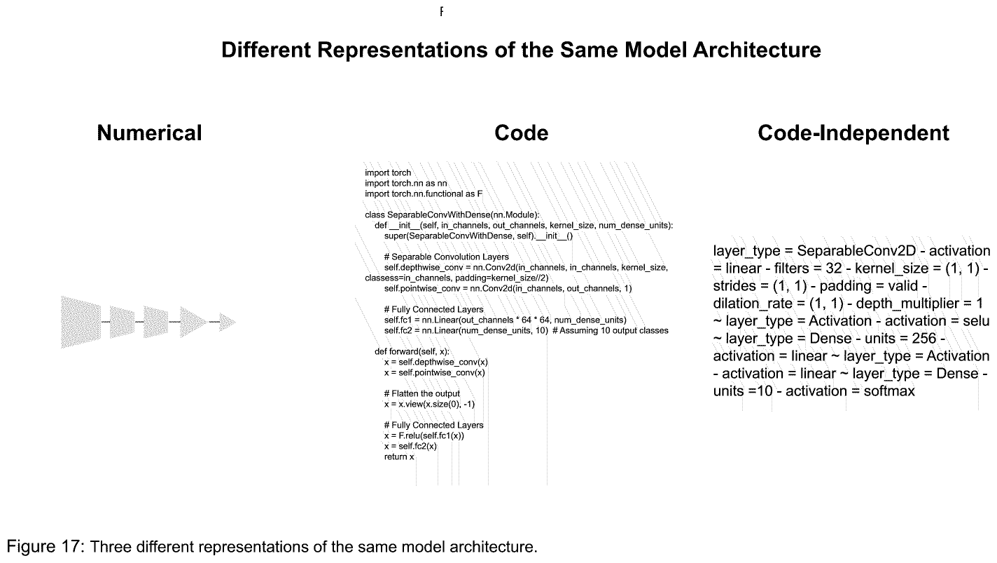

FIG. 17 depicts three different representations of the same model architecture; numerical, code, and code-independent representations. According to certain embodiments of the present invention, a model representation is a text based representation of a machine learning model, which is usually considered a numerical object. Text based representations include, but are not limited to, text comprising code segments that include aspects of open source ML coding libraries (such as tensorflow, keras, pytorch, etc . . . ) that can be used to build a numerical model when compiled and executed, and a code-independent text based representation of ML models that completely describe the mathematical objects within a model (and how they are connected) such that it can be converted to a text based code representation. Model representations may also include custom mathematical objects, and in this case the custom mathematical objects may be stored such that they could be used in a similar manner to aspects of open source ML coding libraries, as described herein.

### Performance Representations

A performance representation may include an ordered or unordered sequence of text which may include one or more of the following element values: classification accuracy (including top-k), mean squared error, memory size of model in number of trainable parameters and file size (mega-bytes), latency of model (time it takes to return output for single input), confusion matrix, time taken to train model, computing resources used, etc. These values can be evaluated for a single evaluation dataset, evaluated separately for each dataset of multiple datasets, or comprise statistical values corresponding to multiple datasets (such as mean, standard deviation, maximum, minimum).

### Other Element Representations

A system and system dataset may benefit from having representations for elements that are relevant to the ML experiment process, such as training details, evaluation details, and human feedback. Training details may be represented in text form listing training parameter values (including, but not limited to, epochs, batch size, learning rate, optimizer, loss function, etc . . . ) or segments of code representing the process of training which can be used to train an ML model within a specific coding framework or library. Epoch refers to the number of times a full dataset is passed through the model. Batch size refers to the number of data elements passed through the model at a time during training.

Evaluation details may be represented in text form listing training parameter values (e.g., metrics used to evaluate performance), segments of code representing the process of evaluation which can be used to evaluate an ML model within a specific coding framework or library, or aspects of evaluation data representation. Human feedback, e.g., manipulations of representations (such as model representations) may be included in a system dataset.

### System Dataset

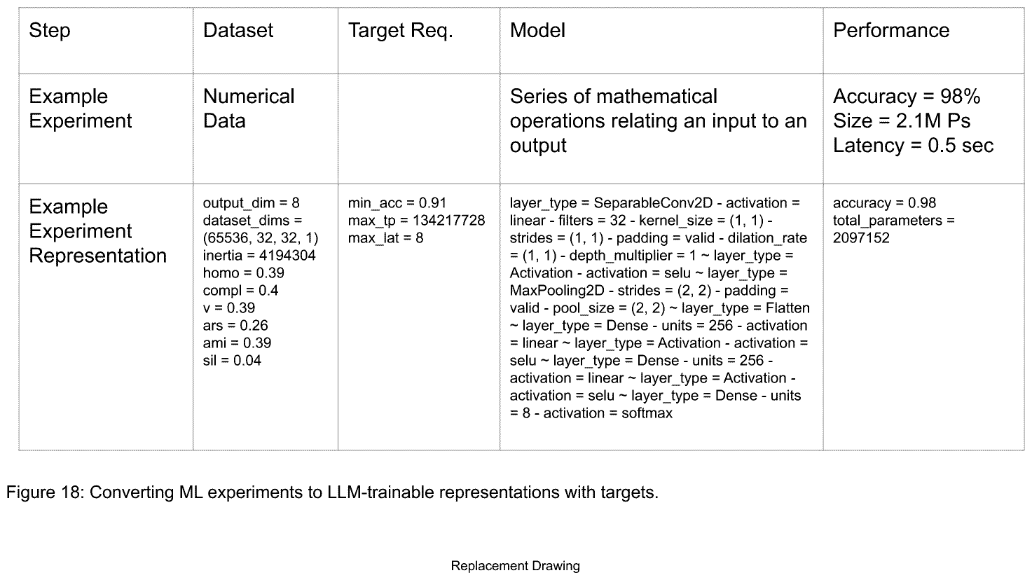

A “system dataset” may include a collection of data elements (See top of FIG. 19), each representing aspects of a machine learning experiment. Referring to FIG. 18, therein is depicted a table illustrating the steps for converting an ML experiment into a representation that large language models can train on. Target requirements that satisfy the performance of the experiment can be randomly generated, creating multiple target requirement representations per experiment. The table shows an experiment as training a numerical ML model on a numerical dataset to obtain performance or evaluation metrics of the trained model on an evaluation portion of the dataset. Elements of an ML experiment can be converted to a textual representation including the following elements, as shown in FIG. 18: A dataset representation, target requirements representation, model representation, and performance representation. FIG. 18 illustrates the steps for converting an ML experiment into a representation that large language models can train on. Target requirements that satisfy the performance of the experiment can be randomly generated, creating multiple experiment representations per experiment. An example of these elements is shown at the top of FIG. 19, of which they are sequentially listed.

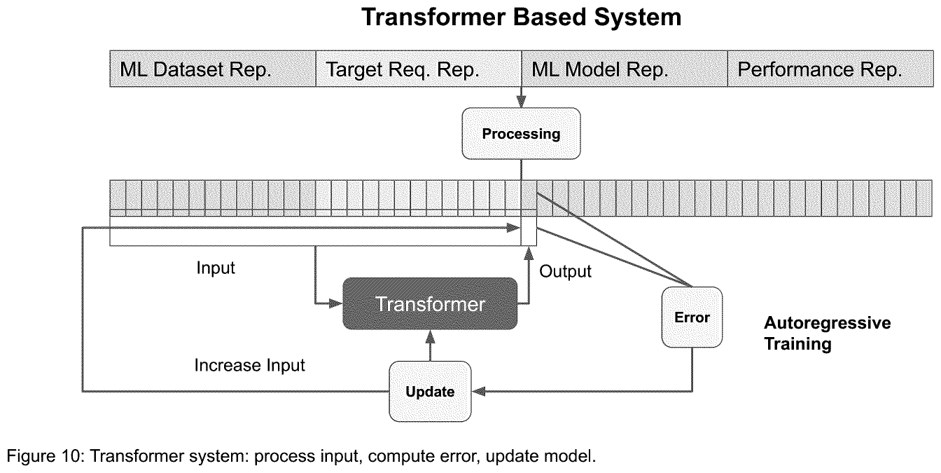

Referring now to FIG. 19, therein is illustrated one implementation of how to take a system dataset of ML experiments and train an autoregressive ML model (e.g., a transformer large language model), such that the ML model learns to predict future words from previous words in each dataset element. Additional details on the autoregressive training process are illustrated in FIG. 10. After training, autoregressive ML models can generate a desired number of text elements (such as characters or words). In one implementation, as shown in FIG. 19, both a dataset and target requirements representation are provided as input to the autoregressive model, and due to the characteristics and organization of the system dataset, the autoregressive model will generate both a model and performance representation.

A transformer is generally a type of deep learning model used for various natural language processing (NLP). It works by taking an input sequence and producing an output sequence. The input sequence, usually a sentence or a paragraph, is first divided into smaller units called tokens. Each token (word or subword) is then represented as a high-dimensional vector (a set of numbers). These vectors capture the meaning and context of each token. Transformers use a self-attention mechanism, which allows the model to weigh the importance of each token in relation to all other tokens in the input sequence. This is done for each token simultaneously and helps the model understand the relationships and dependencies between words or tokens in the input and their position within the sequence.

Transformers typically consist of multiple layers of self-attention mechanisms, one on top of the other. These layers refine the understanding of the input sequence, with each layer learning different patterns and dependencies. The deeper the stack, the more complex relationships the model can capture. These complex relationships are learned by the system of the present invention as part of the training process utilizing the system dataset.

After processing the input through multiple layers, the transformer produces an output sequence. According to an embodiment of the present invention, one implementation generates the output sequence token by token (word or subword), where each token is predicted based on the context of the previous tokens. This is performed using a decoding process that involves generating one token at a time while considering the self-attention mechanism's output from the prior processing. When the decoding process is probabilistic (as is the case with the described embodiment), it is possible to generate unique output sequences that were not encountered during the training of the transformer and which do not exist as a dataset within the system dataset. In one embodiment, instead of producing a single output, the system generates a probability distribution over the possible next tokens at each step. This distribution reflects the uncertainty about what token should come next. Techniques such as beam search or sampling can be used to sample from these distributions to produce diverse and potentially different output sequences. Beam searching is a deterministic decoding strategy that keeps track of the top-k most likely sequences at each step, effectively exploring multiple possible continuations of the sequence. However, it tends to produce more focused and deterministic outputs compared to sampling. Sampling is a truly probabilistic approach where the system randomly samples from the distribution of possible next tokens. It can result in more diverse, but potentially less controlled output sequences.

In general, the transformer takes an input sequence, processes it through multiple layers of self-attention and feedforward neural networks, and generates an output sequence, all while learning to understand and capture complex relationships between the input tokens.

In general, depending on the definition of the system dataset elements and the representations that are included, an autoregressive model in this way can complete any number of remaining relevant ML experiment representations when given at least one as an input. Importantly, some representations can act as “filters” to help generate future representations that are connected to previous representations. For example, the target requirements representation helps to generate a model representation that has a corresponding performance representation that satisfies the target requirements representation. In this way the target requirements representation helps to connect datasets with optimal models, for particular target requirements.

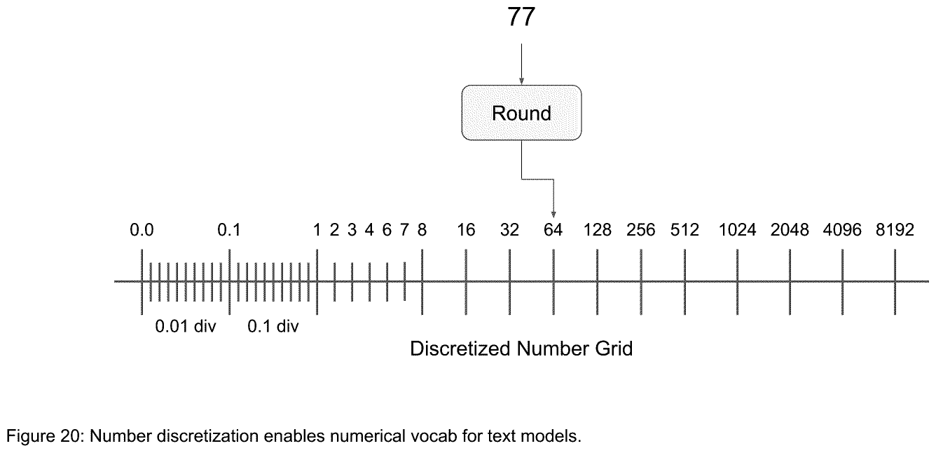

A dataset may be processed in the following manner: discretization of numeric values occurs prior to converting to text. One example of such a discretization process is shown in FIG. 20 where different sized ranges are established for numeric parameters. The ranges can have different sizes to accommodate many magnitudes of numeric ranges, in a similar manner to a logarithmic or exponential scale. For example, as shown in FIG. 20, for relatively small numbers, the numeric ranges span a smaller magnitude of numbers, while for larger numbers, the ranges span a correspondingly larger magnitude of numbers. For example, the size of the range between 2048 and 4096 is roughly comparable to the size of the range between 8 and 16.

Specific characters or words or collections of words can give structure to a representation in the following ways (though not limited to): denoting the relationship between a parameter name and the value, denoting separation between parameters, denoting the start and end point of specific representations. For example, in FIG. 19 the “|” character is meant to separate representations and the “=” character is meant to be placed between a parameter and its value. Each of these represent a single “element” of the vocabulary of the system dataset.

### Large Language Models

According to an embodiment of the present invention, a system's autoregressive ML model (as illustrated in FIG. 19) can be trained (using a process similar to FIG. 10) in the following stages: first, on a raw system dataset, second, continue training on a system dataset that has a specific representation scheme and specific high quality data elements, third, continue training using reinforcement learning methods to adapt the system's autoregressive ML model to new data without losing prior learned information.

A first training stage can refer to training on a system dataset of some or all of the following attributes: not every representation present in the system dataset is in each system dataset element, not every representation of the same type in the system dataset has the same variables, numerical values within data elements can be processed using different methods, some parameter values may be intentionally left out from some data elements, etc For example, an implementation may choose to specifically exclude parameters that require ML model training (e.g., accuracy) from certain representations (such as target requirements and performance) so a larger system dataset can be assembled with less effort.

As an example, an implementation of a first training stage may include a system dataset that is composed of some or all ML experiments that were trained on ML datasets of synthetic data. Synthetic data is data that is generated by a separately trained ML model, but can be used to approximate real world datasets. A dataset such as this may help control the dataset representations that are present in the first stage of training the system autoregressive model.

A second training stage may continue the training of the autoregressive model trained in the first stage on a different system dataset that has data elements that have one or more specific representation strategies. Representation strategy refers to specific representations included and their order. In the second stage it may be beneficial to include data elements in the system dataset that have parameter values for parameters that rely on training ML models (e.g., accuracy). In addition, it may be beneficial to only include high quality data elements in the second stage system dataset, where high quality refers to data elements without errors.

A third training stage may use reinforcement learning methods on the autoregressive model trained in the second stage, such that prior information learned by the second stage model is attempted to be preserved while training continues on a third stage system dataset. Third stage training, however, is different in that it relies on methods from reinforcement learning such as Proximal Policy Optimization (PPO).

### A System to Perform and Aid ML R&D

The present invention may be utilized as an automated background process for ML R&D or an optimal ML model suggestion tool. An automated background process for ML R&D may refer to implementations where one or more ML datasets are stored or accessible in some way such that optimal ML model suggestions may be provided for each ML dataset at pre-defined moments or intervals in time. Each suggestion is converted into a trainable ML model and the model is trained. Such a background process could also keep track of the progress of the system in such a way that the progress can be made available. Automated background processes can be facilitated in the following ways: a command/console line interface tool, a web or desktop based platform performing all/some MLOps process in addition to model suggestions, a code base and software base completely independent of any interaction from the user (only providing trained and validated ML solutions), or a chat bot.

An optimal ML model suggestion tool may refer to interactions with the system where one or more ML datasets are stored or connected to the system in such a way that the system can make optimal ML model suggestions in an interactive manner. These interactions include, but are not limited to, approval or disapproval from a user to proceed with training of the model suggestion, manipulation capabilities of the model suggestion prior to training, etc . . . Optimal ML model suggestion tools can be facilitated for the user, in the following exemplary ways: Command/console line input prompts and displays, interactive coding environments such as coding notebooks or studios [] [visual studio (GHCP)], or chat bots.

Users can contribute to the system in the following exemplary ways: users can share their ML experiments in such a form that is useful for future training of the system autoregressive ML model (large language model) or contribute to the system code and development though open source processes. Users may share their experimentation with the system by directly sharing their training experiments with a coding library that is connected to the system in such a way that the ML experiments can be stored in a useful form, retroactively for previously documented ML experiments (with custom documentation methods, tools such as or similar to MLFlow) posts on platforms like Hugging Face, Google vertex AI, Kaggle, Papers with code, or Github) with a coding library that is connected to the system in such a way that the ML experiments can be stored in a useful form for the above stated system objectives.

### A Single System to Address Many MLOps Tasks

A system and method as described herein can fundamentally learn the connection between dataset representations and optimal model representations. The term optimal refers to model representations where performance representations contain parameter values that “satisfy” a target requirement representation. For example, a performance representation that has an accuracy parameter that is higher in value than the “minimum accuracy” parameter of a given target representation is acceptable. A system as just described would be able to not only identify optimal models for datasets but also help to perform data quality tasks where the elements of ML datasets are manipulated to find a form that has better performance on ML models. The system has the capability to perform data quality tasks, because the system can produce various data representations for an ML dataset and then predict the optimal ML model and the performance of that ML model without ever having trained the model. Additionally, the system is able to provide a method to document and reproduce ML experiments without needing to store them. The system would then allow the opportunity to offer both training and hosting services of ML models, and data storage within the system itself to various users.

### A System to Learn Machine Learning Model Mathematical Objects

Model representation may be constructed such that the base elements of the representation represent base mathematical operations (e.g., addition, subtraction, multiplication, division) and unique sequences and collections of these base mathematical operations. A model representation of this form may allow for a system after having trained on system datasets that leverage data elements with this model representation to generate ML model suggestions that are highly customizable to dataset representations. A model representation of this form would help the system learn to produce unique sequences and collections of base mathematical operations that are competitive, if not more effective, with humans manually experimenting and researching to find new unique sequences and collections that are effective for particular ML tasks. Such a definition would make the system not reliant on human trained ML experiments because this base model representation would allow for the generation of any possible ML model, and a system dataset could be collected through exploring these possibilities iteratively through random grid search. Other iterative approaches similar to autoML may be useful to help explore the space of all possible ML models, though the implicit bias of such approaches may limit the system from achieving optimal potential for learning the connection between dataset representations and optimal model representations.

### Dataset Types

The system and method of the present invention may be applicable for use with many different types of datasets. These datasets may include Tabular Data, which may be structured data in rows and columns, similar to spreadsheets. Examples of such Tabular Data include CSV files and SQL databases. The present invention may also be applicable for use with Text Data, i.e., collections of text documents or strings, such as sentences, articles, books, emails, and the like. The present invention may also be applicable for use with Image Data, i.e., collections of images or visual data, such as photographs, medical images, or satellite images.

The present invention may also be applicable for use with Audio Data, i.e., collections of audio or sound recordings, such as speech, music, or sound effects. The present invention may also be applicable for use with Video Data, i.e., collections of video clips or frames, such as surveillance footage, movie frames, and the like. The present invention may also be applicable for use with Time Series Data, i.e., sequential data indexed by time, such as stock prices, weather data, or sensor readings. The present invention may also be applicable for use with Geospatial Data, i.e., data related to geographic locations, such as GPS coordinates, maps, or spatial databases.

The present invention may also be applicable for use with Graph Data, i.e., dataset represented as graphs with nodes and edges, such as social networks, transportation networks, and the like. The present invention may also be applicable for use with Multi-modal Data, i.e., data that combines multiple types (e.g., text, image, audio), such as video with audio and text captions. The present invention may also be applicable for use with Genomic Data, i.e., data related to DNA and genetics, such as DNA sequences or gene expression data.

The present invention may also be applicable for use with Environmental Data, i.e., data related to the environment and natural phenomena, such as climate data or ecological data. The present invention may also be applicable for use with Financial Data, i.e., data related to financial markets and transactions, such as stock prices or banking transactions. The present invention may also be applicable for use with Biomedical Data, i.e., data related to healthcare and medical research, such as electronic health records or medical images.

The present invention may also be applicable for use with Social Media Data, i.e., data from social media platforms, such as Tweets, Facebook posts, or Instagram photos. The present invention may also be applicable for use with Anomaly Detection Datasets, i.e., datasets specifically designed for anomaly detection tasks, such as credit card fraud data, network intrusion data. The present invention may also be applicable for use with Recommendation System Data, i.e., data related to user preferences and recommendations, such as movie ratings, product reviews.

The present invention may also be applicable for use with Customer Behavior Data, i.e., data related to customer interactions and behavior, such as e-commerce clickstream data or user logs. The present invention may also be applicable for use with Sensor Data, i.e., data from various sensors and IoT devices, such as temperature sensors, motion sensors, and the like. The present invention may also be applicable for use with Categorical Data, i.e., data with categorical variables (non-numeric), such as gender or product categories.

The present invention may also be applicable for use with Ordinal Data, i.e., data with ordered categorical variables, such as education levels or customer satisfaction ratings. The present invention may also be applicable for use with Sequential Data, i.e., data with a temporal sequence, such as DNA sequences or natural language sentences. The present invention may also be applicable for use with Imaging and Video Sequences, i.e., sequences of images or video frames, such as video surveillance or video streaming.

The present invention may also be applicable for use with Satellite and Remote Sensing Data, i.e., data collected from satellites and remote sensors, such as earth observation data or agricultural monitoring. The present invention may also be applicable for use with Time Series Sequences, i.e., sequences of time series data, such as stock market prices over multiple days. The present invention may also be applicable for use with Natural Language Dialog Data, i.e., data representing conversations or dialogues, such as customer support chat logs or chatbot interactions. The present invention may also be applicable for use with Network Data, i.e., data representing network structures, such as social network connections or communication networks.

### ML Task Frameworks

The system and method of the present invention may be used with a number of different ML task frameworks, such as Supervised Learning (classification, regression); Unsupervised Learning (clustering, dimensionality reduction, anomaly detection); Semi-Supervised Learning (combines elements of both supervised and unsupervised learning); Reinforcement Learning (Q-Learning, Deep Q Networks (DQN), Policy Gradient Methods); Natural Language Processing (NLP) (sentiment analysis, Named Entity Recognition (NER), machine translation, text generation, text summarization); Computer Vision (image classification, object detection, image segmentation, facial recognition); Recommendation Systems (collaborative filtering, content-based filtering, hybrid methods); Time Series Analysis (forecasting, anomaly detection, seasonal decomposition); Deep Learning (Convolutional Neural Networks (CNNs), Recurrent Neural Networks (RNNs), Generative Adversarial Networks (GANs), transformers); Supervised Learning Algorithms (linear regression, decision trees, random forest, Support Vector Machines (SVM), -k-Nearest Neighbors (k-NN)).

The system and method of the present invention may additionally be used with a further number of different ML task frameworks, such as Unsupervised Learning Algorithms (-K-Means clustering, hierarchical clustering, principal component analysis (PCA), t-Distributed Stochastic Neighbor Embedding (t-SNE)); Feature Engineering (feature selection, feature scaling, feature extraction); Ensemble Learning (bagging (e.g., Random Forest), Boosting (e.g., AdaBoost, Gradient Boosting), stacking); Transfer Learning (fine-tuning pre-trained models on new tasks); Graph Neural Networks (tasks involving graph-structured data); Deep Reinforcement Learning (combining deep learning with reinforcement learning for complex tasks); Anomaly Detection (identifying rare and unusual patterns in data); Adversarial Attacks and Defense (creating and defending against adversarial inputs in neural networks).

### ML Applications

The system and method of the present invention is applicable for use with any of a number of different ML applications. In the case of Tabular Data, these ML Applications may include credit scoring for loan approval, customer churn prediction, or fraud detection in financial transactions. In the case of Text Data, these ML Applications may include sentiment analysis of customer reviews, spam email detection, or natural language translation. In the case of Image Data, these ML Applications may include object detection in autonomous vehicles, medical image analysis for disease diagnosis, or facial recognition for security systems. In the case of Audio Data, these ML Applications may include speech recognition for virtual assistants, music genre classification, or anomaly detection in audio signals.

In the case of Time Series Data, these ML Applications may include stock price forecasting, energy consumption prediction, or predicting equipment failure in manufacturing. In the case of Geospatial Data, these ML Applications may include GPS navigation and route optimization, environmental monitoring and disaster prediction, or location-based recommendation systems. In the case of Video Data, these ML Applications may include video surveillance for security, action recognition in sports videos or content recommendation for video streaming. In the case of Graph Data, these ML Applications may include social network analysis, recommendation systems based on user interactions, or identifying influential nodes in networks.

In the case of Multi-modal Data, these ML Applications may include video captioning, combining video and text, multimedia content retrieval, or speech-to-text for video content. In the case of Genomic Data, these ML Applications may include identifying genetic markers for diseases, predicting gene function, or clustering DNA sequences for evolutionary analysis. In the case of Environmental Data, these ML Applications may include climate modeling and prediction, ecological species classification, or air quality forecasting. In the case of Financial Data, these ML Applications may include stock price prediction., algorithmic trading, or credit risk assessment.

In the case of Biomedical Data, these ML Applications may include medical image segmentation, disease diagnosis from patient data, or drug discovery and development. In the case of Social Media Data, these ML Applications may include social media sentiment analysis, recommender systems for social platforms, or fake news detection. In the case of Anomaly Detection Datasets, these ML Applications may include fraud detection in credit card transactions, intrusion detection in computer networks, or equipment failure prediction in manufacturing. In the case of Recommendation System Data, these ML Applications may include movie and product recommendations, personalized content recommendations, or restaurant and travel recommendations.

In the case of Customer Behavior Data, these ML Applications may include market basket analysis for retail, customer segmentation, or user behavior modeling for targeted marketing. In the case of Sensor Data, these ML Applications may include predictive maintenance for industrial machinery, environmental monitoring, or health monitoring through wearable sensors. In the case of Categorical Data, these ML Applications may include customer segmentation based on demographics, product categorization in e-commerce, or spam email classification. In the case of Ordinal Data, these ML Applications may include educational performance prediction, customer satisfaction analysis, or ranking and rating prediction in reviews.

In the case of Sequential Data, these ML Applications may include predicting next words in text, predicting stock market trends over time, or music generation. In the case of Imaging and Video Sequences, these ML Applications may include action recognition in video sequences, autonomous vehicle navigation, or sports performance analysis. In the case of Satellite and Remote Sensing Data, these ML Applications may include crop yield prediction, urban planning and development, or environmental monitoring. In the case of Time Series Sequences, these ML Applications may include forecasting electricity demand, predicting patient health trends, or predicting website traffic.

In the case of Natural Language Dialog Data, these ML Applications may include chatbot and virtual assistant development, customer support automation, or speech recognition in dialogues. In the case of Network Data, these ML Applications may include social network influence analysis, recommender systems for online social platforms, or detecting network anomalies.

The following references are hereby incorporated by reference herein in their entirety:
Silhouette Coefficient:
   https://scikit-learn.org/stable/modules/generated/sklearn.metrics.silhouette_score.html
Confusion Matrix: https://en.wikipedia.org/wiki/Confusion_matrix.
CIFAR10: https://paperswithcode.com/dataset/cifar-10
Backpropagation: http://neuralnetworksanddeeplearning.com/chap2.html
MFLow: https://mlflow.org/
Hugging Face: https://huggingface.co/
Google Vertex AI: https://cloud.google.com/vertex-ai
Papers with code: https://paperswithcode.com/
Github: https://github.com/
Kaggle: https://www.kaggle.com/
MLOps: https://www.databricks.com/glossary/mlops
ML Training Terms
   Loss: https://machinelearningmastery.com/loss-and-loss-functions-for-training-deep-learning-neural-networks/
   Class labels: a integer or text label paired to a data element such as an image
   Vocabulary: unique set of “words” in a text based dataset
Background
   Foundation Models: https://www.adalovelaceinstitute.org/resource/foundation-models-explainer/#:˜:text=Foundation%20models%20are%20AI%20models,base'%20for%20many%20other%20applications.
   AutoML Description: https://www.akkio.com/post/how-does-automated-machine-learning-work
   Keras Tuner: https://keras.io/keras_tuner/
   Genetic Algorithms: https://journals.plos.org/plosone/article?id=10.1371/journal.pone.0243030
   Reinforcement Learning AutoML: https://blog.research.google/2017/05/using-machine-learning-to-explore.html
   SMASH: https://arxiv.org/abs/1708.05344.
   Generative Model Selection:
      https://arxiv.org/pdf/2303.17580.pdf
      https://arxiv.org/pdf/2304.14979.pdf
Statistical ML Review: An Introduction to Statistical Learning: with Applications in R (Springer Texts in Statistics)
Transformers
   https://arxiv.org/abs/2106.04554
   https://ieeexplore.ieee.org/document/8694781
   https://ieeexplore.ieee.org/document/8862451
AutoEncoders
   https://en.wikipedia.org/wiki/Autoencoder#:˜:text=An%20autoencoder%20is%20a%20type,data%20from%20the%20encoded%20representation.
Dimensional reduction.
   https://en.wikipedia.org/wiki/Dimensionality_reduction
Kmeans
   https://en.wikipedia.org/wiki/K-means_clustering
Clustering evaluation metrics:
   2.3.11. Clustering performance evaluation: https://scikit-learn.org/stable/modules/clustering.html#clustering-evaluation
Support vector machine
   https://en.wikipedia.org/wiki/Support_vector_machine
Mean Squared Error
   https://en.wikipedia.org/wiki/Mean_squared_error
Elbow Method
   https://www.geeksforgeeks.org/elbow-method-for-optimal-value-of-k-in-kmeans/
Trainable parameters
   https://www.analyticsvidhya.com/blog/2022/10/multi-layer-perceptrons-notations-and-trainable-parameters/
PPO
   https://arxiv.org/abs/1707.06347

What is claimed is:

1. A method for generating a desired machine learning model representation comprising the following steps:
providing as input a dataset representation and one or more target requirements representations for the desired machine learning model representation;
training a transformer using a system dataset including a plurality of machine learning experiments, each machine learning experiment having an associated dataset representation, target requirements representation, model representation, and performance representation; and
using the transformer to generate the desired machine learning model representation having a performance representation which equals or exceeds the target requirements representation.

2. The method of claim 1, wherein the dataset is split into a plurality of batches, and further comprising the steps of each batch being passed through a plurality of mathematical objects of a pretrained foundation model, prior to passing through one or more custom mathematical objects, the output of the last custom mathematical object being compared against a known output for the batch and determining an error as a difference between the output of the last custom mathematical object and the output of the batch, utilizing the error to adapt at least one of the one or more custom mathematical objects.

3. The method of claim 2, further comprising the step of passing the dataset at least a second time through the mathematical objects after the step of updating.

4. A method for generating a plurality of machine learning model representations, each machine learning model representation being generated by performing the following steps:
(a) providing as input a dataset representation and one or more target requirements representations for the desired machine learning model representation;
(b) training a transformer using a system dataset including a plurality of machine learning experiments, each machine learning experiment having an associated dataset representation, target requirements representation, model representation, and performance representation;
(c) using the transformer to generate the desired machine learning model representation having a performance representation which equals or exceeds the target requirements representation; and
arranging the machine learning model representations according to a grid based on fully connected (FC) and convolutional (Conv) layers of the models, and exploring the grid of models until a sufficient model is located.

5. A method for generating a desired machine learning model representation comprising the following steps
determining a model selection prompt;
training a large language model using the model selection prompt;
obtaining suggested models;
training and evaluating the suggested models; and
iteratively repeating the previous steps until a satisfactory model is obtained.

6. The method of claim 1, wherein a system dataset is represented as a dataset representation, a target requirement representation, a model representation, and a performance representation.

7. The method of claim 1, wherein the step of training the transformer comprises the following steps:
utilizing a portion of the dataset and passing it through the transformer to obtain an output;
comparing the output to a known value to obtain an error;
using the error to update the transformer to minimize the error when processing future portions of the dataset;
repeating the utilizing, comparing, and updating steps using increasing portions of the dataset, until the full dataset is utilized.

8. A method for generating a plurality of machine learning model representations, each machine learning model representation being generated by performing the following steps:
(d) providing as input a dataset representation and one or more target requirements representations for the desired machine learning model representation;
(e) training a transformer using a system dataset including a plurality of machine learning experiments, each machine learning experiment having an associated dataset representation, target requirements representation, model representation, and performance representation;
(f) using the transformer to generate the desired machine learning model representation having a performance representation which equals or exceeds the target requirements representation; and
utilizing the machine learning model representation to arrange elements of the dataset according to a two-dimensional space, and determining a division line between the elements of the dataset.

9. The method of claim 1, wherein the elements of the dataset are arranged nonlinearly.

10. The method of claim 1, wherein the training step comprises multiple training stages.

11. The method of claim 10, wherein the multiple training stages comprise a first training stage where not every representation in the dataset is present in each element of the dataset, a second training stage operating on the output of the first training stage on a different dataset having elements having specific representation strategies, and a third training stage operating on the output of the second training stage, the third training stage utilizing reinforcement learning.

12. The method of claim 1, wherein the dataset includes one or more of tabular data, text data, image data, audio data, video data, time series data, geospatial data, graph data, multi-modal data, genomic data, environmental data, financial data, biomedical data, or social media data.

13. The method of claim 1, wherein the dataset includes one or more of anomaly detection datasets, recommendation system data, customer behavior data, sensor data, categorical data, ordinal data, sequential data, natural language dialog data, or network data.

14. A system for generating a desired machine learning model representation comprising:
a processor;
a memory containing instructions, which when executed by the processor cause the processor to perform the following steps:
receiving as input a dataset representation and one or more target requirements representations for the desired machine learning model representation;
training a transformer using a system dataset including a plurality of machine learning experiments, each machine learning experiment having an associated dataset representation, target requirements representation, model representation, and performance representation; and
using the transformer to generate the desired machine learning model representation having a performance representation which equals or exceeds the target requirements representation.

15. The system of claim 14, wherein the dataset is split into a plurality of batches, and further comprising the steps of each batch being passed through a plurality of mathematical objects of a pretrained foundation model, prior to passing through one or more custom mathematical objects, the output of the last custom mathematical object being compared against a known output for the batch and determining an error as a difference between the output of the last custom mathematical object and the output of the batch, utilizing the error to adapt at least one of the one or more custom mathematical objects.

16. The system of claim 14, further comprising the step of passing the dataset at least a second time through the mathematical objects after the step of updating.

17. The system of claim 14, wherein a system dataset is represented as a dataset representation, a target requirement representation, a model representation, and a performance representation.

18. The system of claim 14, wherein the step of training the transformer comprises the following steps:
utilizing a portion of the dataset and passing it through the transformer to obtain an output;
comparing the output to a known value to obtain an error;
using the error to update the transformer to minimize the error when processing future portions of the dataset; and
repeating the utilizing, comparing, and updating steps using increasing portions of the dataset, until the full dataset is utilized.
